(19) United States
(12) Patent Application Publication
(10) Pub. No.: US 2025/0307385 A1
(43) Pub. Date: Oct. 2, 2025

(54) USER IDENTIFICATION AND MONITORING

(71) Applicant: Mimoto, Inc., San Francisco, CA (US)

(72) Inventors: David P. Charboneau, JR., Durham, NC (US); Douglas A. Coburn, Palmdale, CA (US); Kimberly S. Kraunz, Truckee, CA (US); Joshua J. Lee, San Bruno, CA (US)

(21) Appl. No.: 19/236,086

(22) Filed: Jun. 12, 2025

Related U.S. Application Data
(63) Continuation of application No. PCT/US2023/083924, filed on Dec. 13, 2023.
(60) Provisional application No. 63/432,672, filed on Dec. 14, 2022.

(51) Int. Cl. G06F 21/55

(52) U.S. Cl. CPC G06F 21/552; G06F 2221/034

(57) ABSTRACT

A system receives a request to identify a user. The system receives user data from a computing device containing usage data or computing device metadata. The usage data is indicative of a user's pattern of usage of an input device. The pattern of usage is based on a combination of one or more input device usage amount, usage frequency, or usage type. The computing device metadata includes a time of day information, active applications, a user security profile, log file entries, or system information. The system generates, using a machine learning engine, a user profile based on the user data that is unique to the user. The system analyzes the user profile, and determines, using the machine learning engine, an identity of the user. The system determines a security policy based on the identity of the user and executes a security procedure based on the security policy.

### CROSS-REFERENCE TO RELATED APPLICATION

This application is a continuation of International PCT Application No. PCT/US2023/083924, filed Dec. 13, 2023, which claims the benefit of priority to U.S. Provisional Application No. 63/432,672, filed Dec. 14, 2022, each of which are hereby incorporated by reference herein their entireties.

### FIELD

Examples of the disclosure relate generally to systems and methods for computer system security, and more specifically, to systems and methods for identifying the user of a computer system and enforcing policies based upon the identification of a user of a computer system.

### BACKGROUND

Interactive sessions of a computer system are often authenticated. Authenticated interactive sessions require presenting valid credentials to a computer system prior to initiation of the interactive session. Once initiated, an authenticated interactive session can expose metadata to the underlying computer system pertaining to the credentials presented during initiation of the session. This metadata can include a username uniquely identifying an account on the computer system.

Authentication methods vary in complexity. For example, authentication methods can include a simple password prompt-where a shared secret in the form of a password matching an associated username is presented to the computer system in response to a password challenge-or can include multi-factor authentication procedures, such as those involving components such as Time-based One-time Password algorithms (e.g., as described in IETF RFC 6238) or biometric inputs such as fingerprints or facial recognition. Multi-factor authentication methods can prove a person's identity on the premise that an unauthorized actor is unlikely to be able to supply the factors required to satisfy the authentication challenges.

When combined with a predefined rule set, authentication metadata can inform the computer system of what commands a particular user is permitted, or authorized, to perform. This combination of authentication and authorization can be used by computer systems to determine whether or not a command should be executed during an interactive session. Once one or more authentication challenges are completed, computer systems can accept that a user interacting with the system is who they say they are. Some systems may periodically pause an authenticated interactive session to require re-authentication. Overcoming these session timeouts can require completion of a similar procedure to the initial authentication.

A problem with existing authentication and authorization systems as the arbiter of acceptable interactions with a computer system are that they are capable of being compromised; cannot verify that the actor is who they claim to be; and cannot detect if an actor is exhibiting malicious behavior.

Disclosed herein are systems and/or methods for analysis of command patterns; biometric input; log files (e.g., acontextual log files); touch interactions and gestures (e.g., swipes, taps); mouse or input device interactions (e.g., moving, clicking, scrolling); and voice input during interactive sessions on computer systems, which can enable adaptive control of access to command execution on the system-for example, dynamic policy enforcement of configurable actions, based on identification of an entity interacting with the system. By monitoring and analyzing command patterns, computer system security may be employed in an adaptive manner that improves on systems and methods that lack the greater context of multiple input sources. That is, systems and methods disclosed herein can provide more accurate identification and/or authentication and improved integrity compared to existing systems and methods.

### BRIEF SUMMARY

According to an example method, one or more inputs are received at a server from a user of a computing device. An identity of the user is determined based on the one or more inputs. It is determined, based on the state and configuration of the computing device, the credentials authenticated for the user, the determined identity of the user based on the one or more inputs, and the state and configuration of any configured additional integrated data sources, it is determined if there are any relevant policies to be enforced. In accordance with a determination that there are policies to enforce the actions of the relevant policies are executed. Determining the identity of the user comprises communicating, via the agent, first input data to a machine learning engine, receiving, from the machine learning engine, a profile indicative of a profile identity, said profile generated based on the first input data, comparing the received one or more inputs to the profile, and determining, based on said comparing, whether the profile identity corresponds to the identity of the user.

### BRIEF DESCRIPTION OF THE DRAWINGS

FIG. 1 illustrates an example system that can be used to implement one or more aspects of the disclosure.

FIG. 2 illustrates an example flow chart illustrating example processes that can be performed according to some embodiments.

FIG. 3 illustrates an example cloud machine learning engine according to some embodiments.

FIG. 4 illustrates an example computer system for implementing various examples of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

According to some embodiments, a system including a cloud machine learning engine architecture can be comprised of a cloud platform and one or more components. The cloud platform can include a frontend; an application programming interface (API); cloud storage; and a machine learning (ML) engine. In some embodiments, the frontend includes a graphical user interface that end users access to perform management and view results. This component can utilize the API for all actions and may have no direct access to the underlying infrastructure. The API component can have direct access to the database and other services for performing actions or retrieving information. In some embodiments, the cloud storage component is where new policies or visa profiles are stored for a rational agent to retrieve. In some embodiments, a rational agent can post updates to the cloud storage component. In some embodiments, the cloud machine learning engine accesses data returned by rational agents in order to create visa profiles. The cloud machine learning engine also can pull in data from third party resources in order to apply contextual data points to the resulting visa profiles or policy actions. Rational agents include processes that can execute on individual systems in order to identify an entity interacting with the system and to enforce any configured policies. In some embodiments, the cloud platform can include a cloud policy builder that can create new policies based on an administrator configuration or a cloud machine learning engine change.

In embodiments, machine learning models can be used to identify observed behaviors and metadata for an entity (e.g., an unknown user) interacting with a computer system, and attribute them to a known entity. The combination of observed behaviors and metadata can belong to a visa profile that is unique to a person or other entity. Observed behaviors can include interactions with a system such as keypresses, mouse movements, mouse clicks, gestures, taps, swipes, etc. Metadata can include information associated with a behavior such as user credential, time of day, application being run, user security profile, log file entries, system information, etc. A visa profile can include a combination of these variables, at one or more points in time. A visa profile can be used as an input to an attribution process.

A rational agent machine learning engine can perform an attribution process, a collection of data (such as observed behaviors and/or metadata) on a system where a rational agent is installed. The data can be collected at one or more points in time, and compared to one or more visa profiles for known persons, such as according to an attribution model. A failure of the data to match one or more of the biometrics, to some confidence level, may indicate that the observed data may correspond to an unknown person. In some examples, attribution models can include statistical tests, classical machine learning, signal processing, anomaly detection, forecasting, dynamical systems, algebraic geometry or topology, differential geometry, and deep learning methods. In some examples, attribution models can selectively identify data characteristics based on their relevance to a particular task.

In some embodiments, attribution models can include feature engineering to transform keystroke timing differences to a usable format for a given method. A metadata feature vector can be composed of multiple different features. For example, one example feature can describe a probability of a given person logging into a specific system. In an example, this feature can relate the number of hours in a day to a number of times the person has logged into a specific system. In some examples, one or more features can be described by a joint probability distribution.

Models such as described above can be implemented using a hybrid computer architecture that includes, in some embodiments, a locally installed rational agent and a cloud machine learning engine such as described above. The types of models that the agent can use can be constrained by the hardware resources available. For example, models can be constrained by CPU or GPU capabilities (e.g., a number of CPU cores), and by an amount of available system memory. In some cases, using a GPU to accelerate inference for certain types of models includes installing and maintaining a canonical deep learning software stack. Because of resource constraints, agent level models can use classical machine learning and statistical modeling techniques.

A cloud machine learning engine need not have the same hardware limitations as a locally installed rational agent, and may include a global context across all systems. The models used by the engine can include statistical tests, classical machine learning models, differential geometric methods, dynamical system methods, which may not require GPU acceleration, and/or deep learning models or signal processing techniques that require GPU acceleration. A global context can be synthesized from multiple different streaming data sources (e.g., rational agents). Within this context, more sophisticated attribution and anomaly detection models can be used.

In some embodiments, a time-varying visa profile for known persons can be created. Statistical tests may use the visa profile to attribute observed behaviors and metadata on a system to a known person. These methods can include parametric and non-parametric tests. In examples where the distribution of metadata or observed behavior features belong to a parametric distribution, parametric tests can be applied according to techniques familiar to those skilled in the art. In some embodiments, on-parametric testing methods can be used to compare parametric distributions and non-parametric distributions. Such tests include methods using ranks; distances or areas between empirical cumulative distribution functions; location and scale, location and scale and shape, location and scale and autocorrelation, cross-correlation, auto-covariance and cross covariance of one or more visa profile features, as well as the outputs of statistical tests and features. In some embodiments, tests can be conditioned on the collection of metadata for an entity (whether known or unknown).

According to some embodiments, the changes in a visa profile over time can constitute a sequence that can be modeled using time series, dynamical system methods and neural networks. Learning objectives can include predicting one or more pieces of metadata, the composition of a feature, and attribution of observed behaviors to one or more persons or one or more groups of people. Forecasting of these changes can be trained by using methods such as holding out data, masking pieces of data, and sampling data.

In some embodiments, a discrete profile can be created from two or more visa profiles. The creation of a discrete profile can combine observed behaviors and metadata from attributed and unattributed visa profiles. Discrete profiles can be used in generative processes as well as in models for performing attribution or forecasting. Constituent components of the discrete profile can be attributed to the discrete profile when tested. Discrete profiles can be provided as inputs into machine learning models, according to techniques familiar to those skilled in the art.

According to some embodiments, a method includes the construction and/or application of one or more multivariate artificial neural networks. These networks can comprise a plurality of methods and their combinations of recurrent, convolutional, transformed, fully connected, dense and sparse attention methods, and graph networks. In some examples, inputs to the networks include combinations of fixed length vectors of observed behaviors, metadata, policies, and provisioning rules.

According to some embodiments machine learning models are trained according to one or more learning objectives. The learning objectives can include one or more of regression, classification, and predicting masked data. In some embodiments, a sequence of behaviors attributed to a person and metadata can be represented as one or more of a point cloud, a tensor of rank k, a weighted directed acyclic or graph with cycles, or statistical or non-statistical manifold. Algebraic and geometric transformations can be performed to change the representation of behavior and metadata features. In some examples, one or more features such as influential nodes, path lengths, holes, sinks, or eigenvalues can be determined and used as features for training models.

In some embodiments, features of attributed behaviors and metadata can be treated as a time varying feature. A time rate of change for sequential features can be modeled as a dynamical system or be described using linear models, as well as other time dependent methods such as those found in the field of signal processing. Low rank approximation can be used to reduce the dimensionality of the tensor representation of the metadata and attributed behavior features. Issues such as multi collinearity can be eliminated by dimensionality reduction. In examples, an ensuing dataset can be used to find a functional form in a dynamical system or as regressors in forecasting models or time series analysis or some other method for predicting time varying data.

According to some embodiments, a method includes constructing a multivariate bidirectional CNN-LSTM (convolutional neural network long short term memory) model with attention. In some examples, Learning objectives can include a masked behavior/metadata and/or classification. The masking of behavior or metadata can be akin to masking tokens when training bidirectional language models such as ELMo (Embeddings from Language Model) and BERT (Bidirectional Encoder Representations from Transformers). For example, a training set of sequence data can be constructed such that some have the same feature, e.g., a type of login credential, masked for each training example. Previous elements in the sequence can provide forward context for the masked element, and subsequent elements can provide backwards context. These contexts combined can provide context to predict the masked metadata or behavior. In some embodiments, CNN, LSTM, and attention layers extract features, retain context from previous time steps, and modify the feature weighting within the hidden layers respectively.

In some embodiments, an attention layer is analogous to sparse attention techniques, which will be familiar to the skilled artisan. Features for attributed behaviors and metadata can be represented by a graph such as described above. In examples, specific properties of the graph can be represented as entries in a sparsely represented graph. A graph representation of the features can include features of interest that are apparent in other representations. A factorized sparse attention tensor can be used as an attention layer in an encoder-decoder neural network.

In some examples, sparse attention techniques can be made more scalable by exploiting graph properties of language. In example methods, greater attention is paid to more important features, and less attention is paid to less important features, which can change how each node in a graph is connected. In some example attention mechanisms, each node is connected to every node in the graph, such that information is able to flow readily from one node to the next. In some embodiments, a flow of information to specific regions of the graph can be controlled by limiting a number of connections per node or a type of path between nodes. In some embodiments, An output of this model can include a vector representation of the inputs, behavior, and metadata, or other suitable parameters, which may be used to determine cosine similarity, calculate the centroid of a collection of vectors, and perform classification techniques. A vector representation can also be used for subsequent machine learning tasks such as metric distance learning, classification, and regression. For example, the vector representation can be provided as input to neural network models. In some embodiments, regression techniques can be used to estimate the above parameters. In some examples, a machine learning model (e.g., a neural network) can be trained to output the above parameters.

In some embodiments, a distance between different training examples is learned by a model according to a metric distance learning process. Metric distance learning can be used to maximize a distance between dissimilar (e.g., opposite) profiles, while minimizing a distance between similar profiles. In embodiments, a distance can represent a measure of similarity between training examples; visa profiles with similar metadata can have smaller distances while visa profiles with dissimilar metadata can have a larger distance. While using such a method may increase the bias of the models, it will ensure the accurate representation of several different relationships between visa profiles.

Vector representations can allow functionality of a model to be used by another model. For example, in natural language processing systems, the output of a language model (e.g., BERT) can be used by another model for text classification. As another example, vector output from a pose model (e.g., DensePose) can be used for classification by a machine learning model such as AlexNet or ResNet. In some embodiments, models utilized can include feature-specific models, such that outputs of these feature-specific models can be provided as input to larger models. The feature-specific models may be relatively weak. The larger models can then provide output based on inferences using a broader context that local agents do not have.

In some embodiments, a twin neural network architecture can be used for classification. Such an architecture can include two identical neural networks (i.e., neural networks having the same number and type of layers and the same weights). In embodiments, the two neural networks are run in parallel: one for observed behavior and the other for a biometric. The outputs from these networks can be reconciled using a similarity function; the output of the similarity function can be used directly, or can be fed into, e.g., a sigmoid function for a binary classifier or softmax for multiple classes. In some examples, the twin neural network architecture can be extended by adding LSTM layers and attention mechanisms.

In some embodiments, inference is performed using output from the feature-specific models such as described above. In some embodiments, the feature-specific models may infer a value based on a context including a set of metadata or an expected range of parameters for different observed behaviors or metadata. The results from these models can then be used by a global model to make inferences that agent-level models cannot.

In embodiments, reports can be received by a ML engine from individual rational agents installed locally on systems, such as in customers' environments.

In some embodiments, a neural network of a variety of architectures can be constructed to perform regression, classification, and predicting a mask value. In some examples, such architectures can also be used to create embeddings between two different spaces. Networks may be constructed to calculate the properties of a curved space such as curvature, vector bundles, geodesics, paths along curved space. In some examples, architectures may be constructed to serve a neural network representations of statistical test procedures, such as non-parametric methods. Such architectures may be composed of convolutional and non convolutional layers. In some examples, a kernel may be composed of discrete profile masks, anomalies, or observed behavior or metadata. Multiple discrete convolutional layers may be unified into one larger architecture that would feed into others, such as an recurrent neural network. The architectures discussed may be used to predict mask values and perform regression techniques. Time series analysis with recurrent neural networks and other architectures can allow for the use of non-parametric regressors.

In some examples, inputs to a cloud machine learning engine can include customer designations, such as an environment (e.g., development, quality assurance, production); or business roles or positions (e.g., system administrator, marketing, developer). In some examples, inputs can include human inputs, such as keyboard input, mouse input, touch input, audio (e.g., voice), or video. In some examples, inputs can include command line inputs, such as commands and/or arguments used; an order of commands and/or arguments used; a frequency of commands and/or arguments used; or types of commands and/or programs that can be used. In some examples, inputs can include system inputs, such as a username for a logged-in session; a username switched to (e.g., via a sudo or runas command); a hostname (e.g., a hostname of a system interacted with); a wide-area network (WAN) IP address for an agent; a client IP address of a connected session; an operating system type; a keyboard locale; a language setting; a session idle time; or a concurrent login. In some examples, inputs can include log file inputs, such as an authorization log (including, e.g., information related to when a user logs in, such as a session time, an IP address for the user, or an amount of time logged in); a syslog message; or a Windows event log. In some examples, such log file inputs can include a service-specific log, such as a SQL log (which can include information on an activity performed by a user during a session); a SystemD journal log (which can include information on starting/stopping, or enabling/disabling, a service, and which can be tied back to a user performing a command at a particular time); a package manager log (which can include information on a package installation, upgrade, or removal, and which can be associated with a user's activity); or a web service log (which can include information on a web service change that can be associated with a user's activity). In some examples, inputs can include a third party tool or context source, such as a change management tool (which can indicate information associated with system outages or other events that might impact user behavior); a human resources tool (which can indicate information on a user's role in an organization); or an Active Directory, Lightweight Directory Access Protocol (LDAP), or Identity Provider (IDP) tool (which can indicate information related to a user's role, and/or information related to systems that a user should have access to).

In some embodiments, outputs of a cloud machine learning engine can include visa profile matches, expected pieces of metadata given an observed behavior and other metadata, observed behaviors given one or more pieces of metadata, and/or forecasted values for various pieces of metadata and biometrics. Outputs can also include the visa profiles themselves. A profile can include various representations of observed behaviors or metadata.

In some embodiments, components of a cloud machine learning engine's performance are monitored by a set of monitoring models. These models can apply a set of conditions and tolerances to examine over time if the elements of the cloud machine learning engine are within the expected performance parameters. If not, the monitoring models will indicate (e.g., to cloud machine learning engine administrators) that there is a deviation. Monitoring models may use generative methods to create, e.g., adversarial visa profiles, metadata, labels, provisioning rules, policies, anomalies, and attributions to evaluate the integrity of the cloud machine learning engine processes and models.

In some embodiments, a rational agent can execute continuously on a local system in order to identify a person interacting with the system and enforce policies. In some examples where a rational agent executes on a local system, the rational agent may only have local context of the system it is running on, and may be reliant on the visa profiles as provided by the cloud ML engine. In some embodiments, the rational agent can monitor biometric input, contextual metadata, and/or command execution patterns in order to identify the person.

An example method, which can be implemented by one or more systems described herein, compares two independent distributions using non-parametric tests. Example tests can include a Mann-Whitney U Test, a Kolmogorov-Smirnov Test for two independent samples with the biometric fitted using a two parameter Weibull distribution, and a twin neural network. An objective of the non-parametric tests is to ascertain if two distributions of values are drawn from the same population. In some embodiments, the method can compare an observed behavior with a biometric of the same behavior attributed to a known person. Such methods can be applied to different levels of granularity by conditioning the biometric on specific pieces of metadata. For example, a biometric for all keystrokes can be subsetted such that only the keystrokes for a known person on a particular system are being compared to the observed behavior. This subsetting can be thought of as conditioning the set of all keystrokes timing differences for a known person on the specific metadata context, which in this case is a particular system where the behavior is being observed. This method can be implemented on multiple systems. The outcomes of the comparison can then be used to update the visa profile of the known person or inform updates or creation of a visa profile for the observed behaviors which now can be attributed to an unknown entity. The absence of a match to a known visa profile can be logged. The unmatched visa profile and its metadata context can be retained as a visa profile for use in future analysis. In embodiments, the techniques described above are not resource intensive algorithms and do not require specialized hardware such as a GPU, nor a non-standard software stack. These techniques may be well suited to run on the rational agent.

An example method, which can be implemented by one or more systems described herein, relates to a time series analysis of parameters estimated from sample distributions. Example methods estimate various parameters of the non-parametric distribution of the observed behavior using the Central Limit Theorem, which will be familiar to the skilled artisan. In some embodiments, a normal distribution for an estimated observed behavior distribution parameter can be parametrized by a mean and a variance. At several different points in time, data for a particular observed behavior can be collected by the agent. Some example methods can include the Mann-Whitney U Test or the Kolmogorov-Smirnov Test for Two Independent Samples for ascertaining if observed behavior can be attributed to distribution of values of the observed behavior for a list of known people. However, in cases where there is insufficient data for the observed behavior for a time interval, attribution may be difficult or impossible. In some embodiments, the parameters for a sample of different moments of an observed behavior distribution for a person can be forecasted using time series analysis, using techniques known to the skilled artisan. In such embodiments, parameters can be interpolated between sets of attributed observed behavior distributions for a person as a function of time.

In some examples, an interactive session with a computer system occurs over an interface exposed by the computer system.

In some examples, a Command Line Interface (CLI) processes commands to a computer program in the form of lines of text. These commands are entered via a computer terminal, a terminal emulator, or a remote shell client. These textual commands are executed by a command-line interpreter or a command-line processor during an interactive session.

In some examples, a Graphical User Interface (GUI) processes commands to a computer program in the form of events collected through a user's manipulation of an input mechanisms including, but not limited to, a mouse, trackpad, or touch screen. These events are interpreted by the computer system's underlying operating system as command references which correspond to actual commands and are executed by the application which received the input event during an interactive session.

In some examples, a cloud machine learning engine is comprised of a centrally hosted system that is not hosted by a customer and a local agent that is installed in a customer's environment.

In some examples, contextual metadata can be from a number of sources such as log files, usernames, system properties, file information, and network information.

In some examples, command execution patterns can include information on the ways commands is executed along with their parameters and the order in which they are specified.

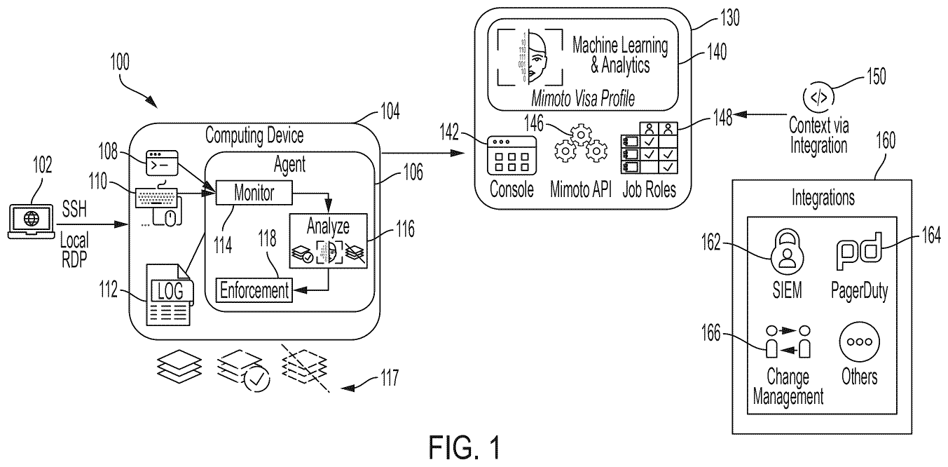

FIG. 1 illustrates a view of an example system 100 that can be used to implement one or more aspects of the disclosure. As shown in the example, a device entity 102 (which can include a laptop or desktop computer, a mobile device, a server, or any other suitable device) is in communication with device 104 (e.g., a server). In some embodiments, device entity 102 can be associated with a human user. In some embodiments, device entity 102 can comprise, be associated with, or be under the control of, a partially or fully automated system (e.g., a “bot”). Rational agent 106 includes one or more processes executing (e.g., continuously) on one or more processors of device 104. A process 114 of rational agent 106 can monitor input to device 104. The input can be provided by an application 108 (e.g., a command-line terminal or an application running on device 104); by an input device 110 (e.g., a keyboard, mouse, touch screen, microphone, camera, or sensor); or by a log file 112 (e.g., a SQL log or SystemD journal log), as described above. At stage 116, rational agent 106 analyzes the input data as described above to determine an identity 117 as described above. Rational agent 106 can perform an enforcement process 118, based on the output of the analysis stage 116, to enforce an action of the session that the identified person is interacting with on the device 104 accordingly. An action can include one or more of terminating the session, disabling the local user credential, alerting on the session, notifying another tool locally, or taking another suitable enforcement action.

Further with respect to the example system 100 shown in FIG. 1, an example cloud platform 130 which can include a cloud machine learning engine 140, which can correspond to a cloud machine learning engine such as described above. Cloud machine learning engine 140 can include, for example, hardware intensive models, models that require a global context, and/or third party data. Cloud machine learning engine 140 can construct visa profiles, as described above, and may perform one or more processes such as anomaly detection, verification of visa profiles in a context not restricted to that of the rational agent, incorporating metadata into analyses, suggesting labels for profiles, and other suitable processes.

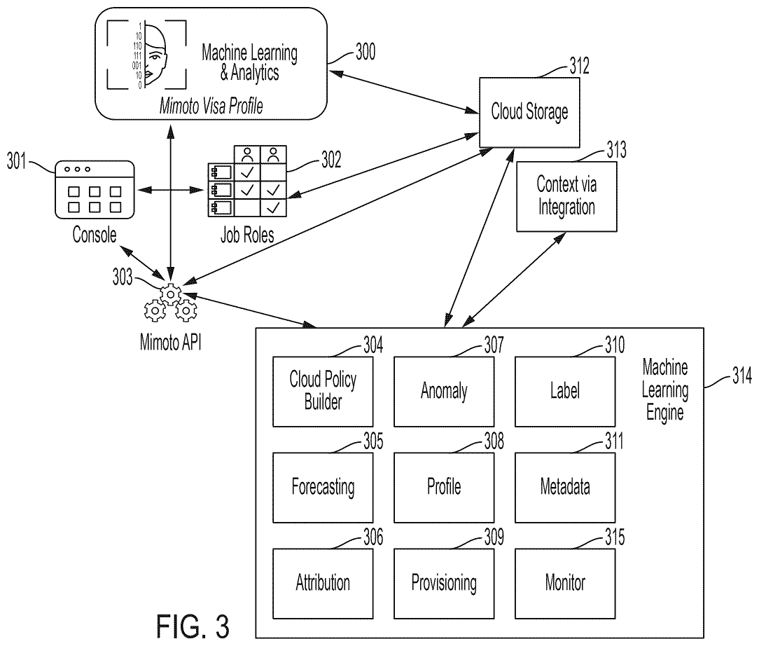

FIG. 1. 160 represents an example system that adds a framework to retrieve data from third party metadata from other systems such as, but not limited to, SIEMs 162, PagerDuty 164, and Change Management tools 166. Third Party data can be fed into the Cloud Machine Learning Engine FIG. 3. 314 to provide additional input.

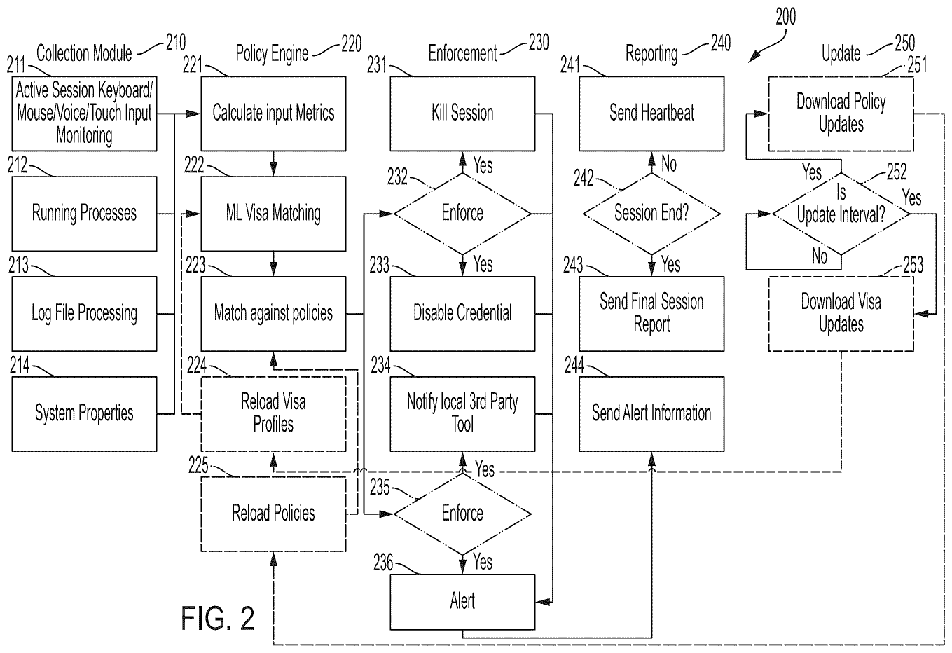

FIG. 2 shows an example flow chart 200, which includes example processes that can be performed by a rational agent or another suitable system element. In embodiments, one or more processes shown in FIG. 2 may be performed as appropriate; not all processes shown in FIG. 2 need be performed or included. Similarly, additional processes not shown in FIG. 2 may be performed as appropriate. One or more processes shown in FIG. 2 can execute concurrently, or in sequence, as appropriate.

In the example flow chart 200 shown in FIG. 2, process 211 can monitor input, such as input from a keyboard, mouse, microphone, touch screen, camera, sensor, or other input device. Process 212 can include one or more system processes, such as system tasks or commands, that can be executed. Process 213 can include processing a log file (e.g., a SQL log file), such as described above. Process 214 can include monitoring, editing, or applying one or more system properties (e.g., network configurations, languages, display settings). One or more of processes 211, 212, 213, and 214, along with other suitable processes, can be performed by a collection module 210 of rational agent 106.

In the example flow chart 200 shown in FIG. 2, process 221 can calculate one or more input metrics, such as described herein. Process 221 can receive input from one or more of processes 211, 212, 213, and 214. An output of process 221 can be provided to process 222, which can perform visa matching, such as described herein. An output of process 222 can be provided to process 223 for matching against configured policies. Based on the result of process 222, process 232 and 235 can execute one or more of actions 231, 233, 234, or 236. The execution of the actions from 232 or 235 can trigger process 244 to notify cloud platform 130.

In some embodiments, process 242 can check on a configured interval for a determination to send an update or on session end, e.g., a heartbeat, to cloud platform 130. Process 241 can trigger an update heartbeat if the configured interval has been satisfied but need not trigger sending the final session report. Process 243 can trigger sending the final update for the session immediately.

In some embodiments, process 252 can check for new visa profile and policy updates at a configured interval. If the configured interval has been satisfied, process 251 can download updated policies and trigger process 225, which can reload the policies into memory. In some embodiments, process 253 can be triggered at the configured interval. Process 253 can download new and/or updated visa profiles into memory.

FIG. 3 shows an example cloud machine learning engine. In some embodiments, the cloud machine learning engine can include a machine learning engine 314. Each of components 304 through 311 can receive input from each of the components. These inputs can be applied to models specific to a respective component.

In some embodiments, a cloud policy builder, 304 constructs policies that are used by one or more rational agents 106. These policies are pushed through the API 303 (identified as Mimoto API in FIG. 3, and which may correspond to API 146 of FIG. 1). One or more rational agents may pull policies by using the API 303.

In some embodiments, a forecasting component 305 applies inputs to predict or create one or more of policies, profiles, labels, attribution, provisioning rules, anomalies, and metadata. The forecasting component can make inferences for some time in the future.

In some embodiments, an attribution component, 306, performs attribution within a global context that may supersede a context of rational agent 106. The attribution component 306 can have access to visa profiles, associated with 300 in FIG. 3, which may include profiles that are not bound to a single organization.

In some embodiments, an anomaly component 307 can have access to a global context as well as the visa profiles; rational agent 106 may not have such access. The anomaly component 307 may detect anomalies in observed behaviors and metadata as well as create anomalies in anticipation of future potential real anomalies.

In some embodiments, a profile component 308 can perform the creation, update, and/or disposal of visa profiles. Profile component 308 can also perform modifying a representation of a profile for compatibility with a model that another component is using.

In some embodiments, a provisioning component 309 can perform creating, updating, destroying, and enforcing policies for the distribution of visa profiles, which may include components other than a rational agent 106. The provisioning of visa profiles can be pushed through the API 303. Visa profiles are also pulled through the API. Push and pull of visa profiles and/or policies may be are permitted or not permitted based on rules set forth by the provisioning component 309.

In some embodiments, a label component 310 can perform one or more of reconciling, creating, updating, removing, and disposing of labels. A reconciliation of labels may be between a console 301 (which may correspond to console 142 of FIG. 1), users and labels generated by the label component 310, or those recommended by other components. The labeling may be of, e.g., visa profiles, policies, provisioning policies, and metadata.

In some embodiments, a metadata component 311 can perform one or more of creation, update, and destruction of metadata. The metadata component 311 may operate in conjunction with the profile component 308 to create new metadata contexts for one or more profiles.

In some embodiments, the machine learning engine 314 can receive inputs from one or more of a job roles component 302, API 303, visa profiles (of 300), cloud storage 312, and a context via integration component 313 (which may correspond to 150 of FIG. 1). The job roles component 302 may be responsible for the mapping of an organization's job roles to a machine-readable format that can be used by the machine learning engine 314. In some embodiments, roles are persistently stored via cloud storage 312. The cloud machine learning engine may interacts with other components via API 303. Visa profiles of 300 may include one or more special visa profiles that are not organization specific. These profiles may be persistently stored via cloud storage 312. The context via integrations component 313 can include third party metadata, data provided by integrations with systems external to the ecosystem, as well as custom integrations. These inputs can be used by the machine learning engine 314. Console component 301 may include a human-machine interface with which an administrative user can controls their organization's cloud machine learning implementation.

In some embodiments, a monitoring component 315 can analyze a performance of one or more components of the machine learning engine 314. The monitoring component may be analyze the processes and outputs of machine learning engine 314 components to ensure compliance with a set of tolerances.

Examples described herein can be performed or implemented via one or more computers, computing devices, or computing systems (including conventional computers and including mobile devices, such as smartphones). Examples of the disclosure may be implemented in any suitable form, including hardware, software, firmware, or any combination of these, using any suitable programming language or technology. Devices used to implement examples of the disclosure can include one or more processors (e.g., CPUs, GPUs, DSPs) configured to execute instructions stored on transitory or non-transitory computer-readable media, thereby performing one or more steps of one or more methods described herein. For example, computer-readable media can include optical media (e.g., CD-ROM, DVD-ROM, Blu-Ray, etc.); a memory; or any other medium capable of being accessed by a computer. Embodiments described herein can be implemented in any suitable format, including hardware or software in any suitable combination. A communications network (e.g., the Internet) can be used to communicate data between two or more elements or nodes of a system described herein, such as between two computers or other devices (e.g., smartphones or mobile devices). These communications can include communication via wired (e.g., Ethernet) or wireless (e.g., Wi-Fi, Bluetooth) communication channels and digital or analog communication channels. Other suitable technologies for implementing the examples disclosed herein will be familiar to the skilled artisan and are within the scope of this disclosure.

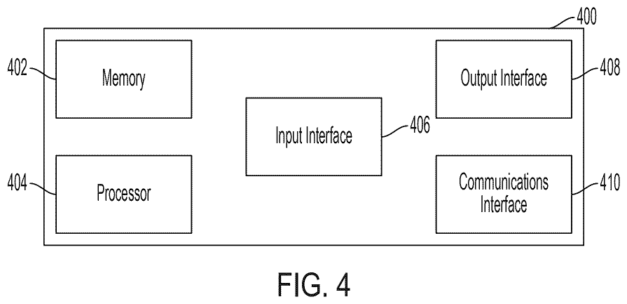

FIG. 4 illustrates an example computer 400 such as described above. Computer 400 can be used to implement one or more of the example methods described herein. As shown in the figure, the example computer 400 includes or communicates with a memory 402, a processor 404, an input interface 406, an output interface 408, and a communications interface 410. Memory 402 may include volatile storage (e.g., random access memory (RAM)) and non-volatile storage (e.g., read only memory (ROM) of a hard disk). Non-volatile storage can include application programs and/or an operating system. In some examples, the systems and methods described herein may be implemented via application programs executing on a server. Processor 404 can include any suitable processor or processors (e.g., one or more CPUs, GPUs, DSPs) for executing instructions, such as instructions stored in memory 402. Input interface 406 may include any suitable interface to computer 400, such as a keyboard, mouse, touch screen, camera, microphone, sensor, or biometric device. Output interface 408 may include any suitable output device for computer 400, such as a conventional display, a printer, a head-worn virtual reality or augmented reality display. Communications interface 410 can allow communication between devices or nodes on a network, such as described above. In some examples, the memory 402, processor 404, input interface 406, output interface 408, and communications interface, or any suitable combination of the above, can be interconnected by a bus. The skilled artisan will appreciate that the above description of an example computer system 400 is non-limiting and that any suitable component, technology, or combination of the above for computer system 400 is within the scope of the disclosure.

According to one or more examples of the disclosure, a method for the continuous determination of user identity, the continuous monitoring of the activity of user identities, the continuous recording of the activity of user identities, and the continuous response to the activity of user identities, comprises: a rational agent at the computing device comprising accepting one or more contextual inputs from one or more sources, creating one or more outputs, installed on one or more computing devices, applying inputs into a machine learning model; a cloud machine learning engine comprising accepting one or more contextual inputs from one or more sources, creating one or more outputs, applying inputs into one or more machine learning models; a policy engine comprising accepting one or more configured criteria of enforcement based on the matching of a known or unknown visa profile; and a visa profile comprising: an aggregation into a data structure a series of one or more metadata labels and one or more associated values of an observed behavior.

In some examples, the policy engine accepts one or more inputs including but not limited to from a cloud machine learning engine and from an administrator to create one or more policies.

In some examples, a rational agent is characterized by continuously, receiving inputs from the computing device the rational agent is installed on, monitoring Human Inputs, system contextual inputs, and third-party contextual metadata, applying one or more inputs including but not limited to: agent updates, visa profiles, policies, and inputs from the computing device to a local rational agent machine learning engine, creating one or more contextual outputs with or without metadata, continuously accepting one or more contextual inputs from one or more sources including but not limited to a cloud machine learning engine, a policy engine, and one or more observed behaviors or one or more actions from an unverified or verified source, and one or more sources of data from monitoring a system where the rational agent is installed while also providing zero or more contextual outputs to a but not limited to cloud machine learning engine.

In some examples, a cloud machine learning engine is characterized by accepting one more input from a plurality of sources wherein the inputs include but are not limited to third party data, metadata, telemetry data, data one or more rational agents and observed behaviors, and actions from a verified or an unverified source which can be represented as a tensor. In some examples, inputs to the Rational Agent ML Engine that can be included into the report up to the Cloud ML Engine can include customer designations, such as an environment (e.g., development, quality assurance, production); or business roles or positions (e.g., system administrator, marketing, developer).

In some examples, inputs can include human inputs, such as keyboard input, mouse input, touch input, audio (e.g., voice), or video.

In some examples, inputs can include command line inputs, such as commands and/or arguments used; an order of commands and/or arguments used; a frequency of commands and/or arguments used; or types of commands and/or programs that can be used.

In some examples, inputs can include system inputs, such as a username for a logged-in session; a username switched to (e.g., via a sudo or runas command); a hostname (e.g., a hostname of a system interacted with); a wide-area network (WAN) IP address for an agent; a client IP address of a connected session; an operating system type; a keyboard locale; a language setting; a session idle time; or a concurrent login.

In some examples, inputs can include log file inputs, such as an authorization log (including, e.g., information related to when a user logs in, such as a session time, an IP address for the user, or an amount of time logged in); a syslog message; or a Windows event log.

In some examples, such log file inputs can include a service-specific log, such as a SQL log (which can include information on an activity performed by a user during a session); a SystemD journal log (which can include information on starting/stopping, or enabling/disabling, a service, and which can be tied back to a user performing a command at a particular time); a package manager log (which can include information on a package installation, upgrade, or removal, and which can be associated with a user's activity); or a web service log (which can include information on a web service change that can be associated with a user's activity).

In some examples, inputs can include a third party tool or context source, such as a change management tool (which can indicate information associated with system outages or other events that might impact user behavior); a human resources tool (which can indicate information on a user's role in an organization); or an Active Directory, Lightweight Directory Access Protocol (LDAP), or Identity Provider (IDP) tool (which can indicate information related to a user's role, and/or information related to systems that a user should have access to).

In some examples the inputs are applied to a collection of machine learning algorithms including but not limited to classical machine learning methods, artificial neural networks, dynamical systems, graph-based methods, statistical methods, and topology and differential geometry methods.

In some examples, the policy engine is characterized by continuously accepting the determination of the machine learning model of the user activity belonging to a known Visa Profile or unknown identity and enforcing defined actions on the computing device where the Rational Agent is located.

In some examples, the rational agent continuously applies one or more inputs including the monitoring of observed behaviors, and a metadata context created by environment with in which the observed behavior is being performed, to a local machine engine to match the observed behavior to a visa profile and communicates the outputs to a cloud machine learning engine.

In some examples, the rational agent continuously enforces one or more actions, such as but not limited to terminating the session, disabling the credential locally, alerting, or notifying a third-party tool in response to user activity based on the determined or undetermined visa profile of the user and inputs from monitoring the system on which the agent is installed.

In some examples, a visa profile comprises a series of entries in a data structure where each entry consists of a metadata label and an associated value of an observed behavior or additional metadata labels and observed behavior pairs, that are attributed to a known person or are labeled but not limited to unknown, anomalous, or an aggregation or distillation of more than one visa profile. In some examples the Visa Profile and metadata constitute a tensor of rank k. The tensor can change representations by applying linear and nonlinear transformations.

In some examples, a baseline attributed visa profile is created in one or more environment of absolute trust and complete certainty that the observed behaviors are associated with the person performing the behavior.

In some examples, one or more visa profiles are used as an input to one or more machine learning models for the purposes of but not limited to: determining if one or more observed behaviors can be attributed to a person with an existing profile, ascertaining if the observed behaviors are anomalous, or to inform the creation, update or deletion of a policy, which rational agents one or more visa profiles should be sent or removed. In some examples one or more machine learning models are used to create, update, destroy, and provision Visa Profiles within zero or more metadata contexts.

In some examples, one or more attributed visa profiles are used in one or more environments of questionable trust and imperfect certainty that the observed behaviors and metadata are associated with the person performing the behavior.

In some examples, the tensor may be represented as a vector space. A subspace may have one or more coordinate systems. Such coordinate systems may be formed by but not limited to metadata, functions, and random variables.

In some examples, the elements of a subspace are used as inputs into one or more machine learning algorithms such as statistical tests. In some instances, the basis elements are used to create a probability mass function. This mass function is used to compute probabilities to scale the results of series of statistical tests applied to observed behaviors that are within the subspace. These statistical tests include but are not limited nonparametric statistical methods that are based on combinations of ordinal ranking, empirical cumulative distribution functions, location and scale, and combinations of correlation, autocorrelation, covariance, and autocovariance. The inputs to these tests are two sets of observed behaviors where each set is of arbitrary size, where one set is for a Visa Profile attributed to a known person and the second set for an unknown person. The ensuing test statistic is used to compute a probability value based on a lookup in a precomputed table. In some instances where a table could not be found, the table was computed using Monte Carlo and distributed computing methods.

In some examples, the elements of the subspace can be represented by a point cloud. In such a representation rules regarding the aggregation of points over time can be created. The aggregation of points in the cloud constitutes features representing values produced by various mathematical methods such as computing eigenvalues. The changes in time of the positions of the particles can be treated as a dynamical system. As a dynamical system a plurality of methods for calculating the functional form of solutions can be used such as variation of parameters, Fourier and Laplacian transformations, as well as methods for solving simultaneous systems of equations.

In some examples, the subspace may be represented as a weighted acyclic or cyclic graph. Each node may correspond to a plurality of values including but not limited to such as a particular observed behavior, one or more pieces of metadata, discrete profile, commands, processes, Visa Profiles, etc. The edges may correspond to similar list. Paths can represent the Visa Profile of a person.

In some examples, a collection of machine learning algorithms are trained using a plurality of methods such as holding out data, masking sequential values. In some examples data is split into multiple sets where one of the sets is not used for training. This set is used to evaluate the model performance.

In some examples a sequence of values may have one or more values held out by using a mask. A forward context are the values leading up to the masked values. A backwards context are the values after the masked values. The learning objective is to predict the masked values.

In some examples a representative subsample of an observed behavior and metadata context may be created by repeatedly sampling from the set of an observed behavior and metadata and using the candidate subsample and the parent set as inputs into a statistical test. This process is repeated until the trained subsample has achieved a probability value exceeding some threshold.

In some examples, neural network type models are used to perform regression and classification of observed behaviors and metadata. In some examples a time series analysis is performed with a recurrent neural network with long term short term memory layers. The time series analysis forecasts changes in, but not limited to, a Visa Profile and metadata. In such analysis multiple points in time may be labeled as “moments of absolute trust and completely certainty” which serve as fiducials for observed behaviors and metadata. Such fiducials may be masked in training. The values after one fiducial and before another create an interval in time within which neural network is to be trained or perform inference on.

In some examples, several layers of a neural network may be trained to function as a statistical test. An input would be fixed length input vector of a trained subsample of an observed behavior and metadata. The layer may be added to a larger architecture where the evaluation of a particular statistical test is needed.

In some examples, a twin network architecture may be used to represent a statistical test procedure. Two fixed length trained subsample vectors with metadata serve as inputs. The model ascertains if an input can be attributed to a Visa Profile. Such an architecture can also be used to compare a trained subsample vectors with metadata to a known library of anomalies.

In some examples, the properties of a vector space transformed into a graph representation can inform the weights of a sparse attention mechanism. The attention mechanism in conjunction with a recurrent neural network architecture with long term short term memory cells and multiple twin architecture layers can be used to perform including but not limited to anomaly detection, regression, classification, and as a generative model for the creation of discrete profiles, Visa Profiles, metadata, labels, and inform policy generation.

In some examples, a transformer based neural network architecture is used to create an embedding transforming points in a Euclidian space to points in a differentiable statistical manifold and vice versa. The function created by the neural network is bijective.

In some examples, a collection of machine learning models are used to create zero or more outputs from generative models.

In some examples, these models create outputs including but not limited to policies, provisioning rules, attribution, metadata from a plurality of sources, discrete profiles, labels, and anomalies. Some of these outputs can be adversarial examples that are used to test the integrity of the Cloud ML engine models and processes.

In some examples, the deviation from a set of conditions by the Cloud ML engine models and processes are reported to the maintainer of the Cloud ML engine.

In some examples, the combining of two or more attributed or unattributed Visa

Profiles is used to create a third discrete profile.

In some examples, this third profile represents the common observed behaviors and metadata between the two or more Visa Profiles. The constituents of the discrete profile are attributable to the discrete profile when tested for attribution. This may include the attribution to a previously unattributed Visa Profile.

In some examples, the discrete profile is used in but not limited to anomaly detection, generative processes for creating policies, provisioning rules, profiles, attribution, metadata, labels, as well as in forecasting methods.

In some examples, a discrete profile can serve as a proxy for a missing Visa Profile.

In some examples, a discrete profile may be provisioned to one or more Rational Agents.

In some examples, a system comprises one or more processors configured to perform one or more of the methods described above.

In some examples, a non-transitory computer-readable storage medium stores instructions which, when executed by one or more processors, cause the one or more processors to perform one or more of the methods described above.

### EXAMPLE

In one example, the system includes at least one hardware processor and at least one non-transitory memory storing instructions, which, when executed by the at least one hardware processor, cause the system to enforce the authentication or security policy.

The system can receive a request to identify a user. The system can receive user data from a computing device. The user data contains usage data or computing device metadata. The usage data is indicative of the user's pattern of usage of an input device, where the pattern of usage is based on a combination of one or more input device usage amount, usage frequency, or usage type. In one example, the input device is a keyboard, computer mouse, touchscreen, or computer trackpad. The computing device metadata includes a time of day information, active applications, a user security profile, log file entries, or system information. In one example, the user data further includes third-party data, telemetry data, command line inputs, usernames, or customer designations. In another example, the user data is collected using a rational agent locally installed on the computing device, where the rational agent is configured to monitor usage of the computing device.

The system can generate, using a machine learning engine, a user profile based on the user data, where the user profile is unique to the user. In one example, the system determines changes in the user's pattern of usage of the input device. The system predicts changes to the usage data based on the changes in the user's pattern of usage of the input device and updates the known user profile based on the predicted changes to the usage data.

The system can analyze the user profile. The system can determine, using the machine learning engine, the identity of the user based on the analyzing of the user profile. In one example, the system can receive, from the machine learning engine, a user profile generated based on the user data. The system can compare the user profile to a series of known user profiles, where the comparison determines that the user profile matches a known user profile. The system can determine, based on said comparison, the identity of the user. In another example, the system calculates a confidence level of the identity of the user, where the confidence level corresponds to the level of certainty in the determining of the identity of the user. A confidence level below a predetermined threshold indicates an unknown identity of the user. In another example, the system determines the user profile corresponds to an unknown user identity and denies the authentication request. In another example, the system can receive a request to identify an authenticated user. The system can determine the authenticated user corresponds to an unknown user identity and revoke a security privilege of the authenticated user. The system can determine a security policy based on the identity of the user. The system can execute a security procedure based on the security policy.

Although the present invention has been fully described in connection with examples thereof with reference to the accompanying drawings, it is to be noted that various changes and modifications will become apparent to those skilled in the art. Such changes and modifications are to be understood as being included within the scope of the claimed subject matter. The various examples of the invention should be understood that they have been presented by way of example only, and not by way of limitation. Although the invention is described above in terms of various examples and implementations, it should be understood that the various features and functionality described in one or more of the individual examples are not limited in their applicability to the particular example with which they are described. They instead can, be applied, alone or in some combination, to one or more of the other examples of the invention, whether or not such examples are described, and whether or not such features are presented as being a part of a described example. Thus the breadth and scope of the claimed subject matter should not be limited by any of the above-described examples.

Terms and phrases used in this document, and variations thereof, unless otherwise expressly stated, should be construed as open ended as opposed to limiting. As examples of the foregoing, the term “including” should be read as meaning “including, without limitation” or the like; the term “example” is used to provide exemplary instances of the item in discussion, not an exhaustive or limiting list thereof; and adjectives such as “conventional,” “traditional,” “normal,” “standard,” “known,” and terms of similar meaning, should not be construed as limiting the item described to a given time period, or to an item available as of a given time. These terms should instead be read to encompass conventional, traditional, normal, or standard technologies that may be available, known now, or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated. For example, “at least one” may refer to a single or plural and is not limited to either. The presence of broadening words and phrases such as “one or more,” “at least,” “but not limited to,” or other like phrases in some instances shall not be read to mean that the narrower case is intended or required in instances where such broadening phrases may be absent. The word “exemplary” is used herein to mean “serving as an example or illustration.” Any aspect or design described herein as “exemplary” is not necessarily to be construed as preferred or advantageous over other aspects or designs.

It will be appreciated that, for clarity purposes, the above description has described examples of the invention with reference to different functional units and modules. However, it will be apparent that any suitable distribution of functionality between different functional units, processing logic elements or domains may be used without detracting from the invention. For example, functionality illustrated to be performed by separate processing logic elements, or controllers, may be performed by the same processing logic element, or controller. Hence, references to specific functional units are only to be seen as references to suitable means for providing the described functionality, rather than indicative of a strict logical or physical structure or organization. It should be understood that the specific order or hierarchy of steps in the processes disclosed herein is an example of exemplary approaches. Based upon design preferences, it is understood that the specific order or hierarchy of steps in the processes may be rearranged while remaining within the scope of the claimed subject matter. Further, in some examples, some steps in the processes disclosed herein may be forgone altogether while remaining within the scope of the claimed subject matter.

We claim:

1. A method comprising:
receiving a request to identify a user;
receiving user data from a computing device,
wherein the user data contains usage data or computing device metadata,
wherein the usage data is indicative of a user's pattern of usage of an input device,
wherein the pattern of usage is based on a combination of one or more input device usage amount, usage frequency, or usage type, and
wherein the computing device metadata includes a time of day information, active applications, a user security profile, log file entries, or system information;
generating, using a machine learning engine, a user profile based on the user data,
wherein the user profile is unique to the user;
analyzing the user profile;
determining, using the machine learning engine, an identity of the user based on the analyzing of the user profile;
determining a security policy based on the identity of the user; and
executing a security procedure based on the security policy.

2. The method of claim 1, wherein determining the identity of the user further comprises:
receiving, from the machine learning engine, the user profile generated based on the user data;
comparing the user profile to a series of known user profiles,
wherein the comparing determines that the user profile matches a known user profile; and
determining, based on said comparing, the identity of the user.

3. The method of claim 1:
wherein the user data is collected using a rational agent locally installed on the computing device, and
wherein the rational agent is configured to monitor usage of the computing device.

4. The method of claim 1 further comprising:
calculating a confidence level of the identity of the user,
wherein the confidence level corresponds to the level of certainty in the determining of the identity of the user, and
wherein a confidence level below a predetermined threshold indicates an unknown identity of the user.

5. The method of claim 1 further comprising:
determining changes in the user's pattern of usage of the input device;
predicting changes to the usage data based on the changes in the user's pattern of usage of the input device; and
updating a known user profile based on the predicted changes to the usage data.

6. The method of claim 1, wherein the user data further includes:
third-party data,
telemetry data,
command line inputs,
usernames, or
customer designations.

7. The method of claim 1 further comprising:
determining the user profile corresponds to an unknown user identity; and
denying an authentication request.

8. The method of claim 1 further comprising:
receiving a request to identify an authenticated user;
determining the authenticated user corresponds to an unknown user identity; and
revoking a security privilege of the authenticated user.

9. The method of claim 1, wherein the input device is a keyboard, computer mouse, touchscreen, or computer trackpad.

10. A system comprising:
at least one hardware processor; and
at least one non-transitory memory storing instructions, which, when executed by the at least one hardware processor, cause the system to:
receive a request to identify a user;
receive user data from a computing device,
wherein the user data contains usage data or computing device metadata,
wherein the usage data is indicative of a user's pattern of usage of an input device,
wherein the pattern of usage is based on a combination of one or more input device usage amount, usage frequency, or usage type, and
wherein the computing device metadata includes a time of day information, active applications, a user security profile, log file entries, or system information;
generate, using a machine learning engine, a user profile based on the user data,
wherein a user profile is unique to the user;
analyze the user profile;
determine, using the machine learning engine, an identity of the user based on the analyzing of the user profile;
determine a security policy based on the identity of the user; and
execute a security procedure based on the security policy.

11. The system of claim 10, wherein determining the identity of the user further comprises:
receive, from the machine learning engine, a user profile generated based on the user data;
compare the user profile to a series of known user profiles,
wherein the comparing determines that the user profile matches a known user profile; and
determine, based on said comparing, the identity of the user.

12. The system of claim 10:
wherein the user data is collected using a rational agent locally installed on the computing device, and
wherein the rational agent is configured to monitor usage of the computing device.

13. The system of claim 10 further comprising:
calculate a confidence level of the identity of the user,
wherein the confidence level corresponds to the level of certainty in the determining of the identity of the user, and
wherein a confidence level below a predetermined threshold indicates an unknown identity of the user.

14. The system of claim 10 further comprising:
determine the user profile corresponds to an unknown user identity; and
deny the request to identify the user.

15. The system of claim 10, wherein the input device is a keyboard, computer mouse, touchscreen, or computer trackpad.

16. A non-transitory, computer-readable storage medium comprising instructions recorded thereon, wherein the instructions when executed by at least one data processor of a system, cause the system to:
receive a request to identify a user;
receive user data from a computing device,
wherein the user data contains usage data or computing device metadata,
wherein the usage data is indicative of a user's pattern of usage of an input device,
wherein the pattern of usage is based on a combination of one or more input device usage amount, usage frequency, or usage type, and
wherein the computing device metadata includes a time of day information, active applications, a user security profile, log file entries, or system information;
generate, using a machine learning engine, a user profile based on the user data,
wherein a user profile is unique to the user;
analyze the user profile;
determine, using the machine learning engine, an identity of the user based on the analyzing of the user profile;
determine a security policy based on the identity of the user; and
execute a security procedure based on the security policy.

17. The non-transitory, computer-readable storage medium of claim 16, further comprising:
receive, from the machine learning engine, a user profile generated based on the user data;
compare the user profile to a series of known user profiles,
wherein the comparing determines that the user profile matches a known user profile; and
determine, based on said comparing, the identity of the user.

18. The non-transitory, computer-readable storage medium of claim 16, further comprising:
calculate a confidence level of the identity of the user,
wherein the confidence level corresponds to the level of certainty in the determining of the identity of the user, and
wherein a confidence level below a predetermined threshold indicates an unknown identity of the user.

19. The non-transitory, computer-readable storage medium of claim 16, wherein the input device is a keyboard, computer mouse, touchscreen, or computer trackpad.

20. The non-transitory, computer-readable storage medium of claim 16, wherein the user data further includes:
third-party data,
telemetry data.
command line inputs.
usernames, or
customer designations.
